(19) United States
(12) Patent Application Publication
(10) Pub. No.: US 2015/0142744 A1
(43) Pub. Date: May 21, 2015

(54) SYSTEMS AND METHODS FOR MEDIA FILE MANAGEMENT

(71) Applicant: VersaPub, Inc., Beaverton, OR (US)

(72) Inventors: Andrew Weinstein, Katonah, NY (US); Jonathan Nathan, New York, NY (US)

(21) Appl. No.: 14/400,263

(22) PCT Filed: May 22, 2013
(86) PCT No.: PCT/US13/42319

§ 371 Date: Nov. 10, 2014

Related U.S. Application Data
(60) Provisional application No. 61/650,633, filed on May 23, 2012.

(51) Int. Cl. G06F 3/06; G06F 17/30

(52) U.S. Cl. CPC G06F 3/0643; G06F 17/30115
USPC 707/640; 707/748; 707/821

(57) ABSTRACT

Systems, apparatus, methods, articles of manufacture, and interfaces for electronic media file (e.g., e-book) management are provided. Data descriptive of electronic media files (e.g., e-books, video, and/or audio files) may be searched, scanned, looked-up, and/or otherwise acquired. Such data may be utilized to determine an authenticity and/or availability of a particular media file. Digital Rights Management (DRM) and/or other related files and/or information may be analyzed, for example, to determine a likelihood or probability that a particular media file is (i) available and/or accessible and/or (ii) authentic. The likelihood of a media file being available and/or authentic may be utilized to select and/or provide content to a user such as one or more advertisements, rewards and/or promotions (e.g., from a third-party).

### CROSS-REFERENCE TO RELATED APPLICATIONS

The present application is a non-provisional of, and claims benefit and priority under 35 U.S.C. §119(e) to, U.S. Provisional Patent Application No. 61/650,633 filed on May 23, 2012 and titled “SYSTEMS AND METHODS FOR ELECTRONIC MEDIA MANAGEMENT AND MARKETING”, the entirety of which is hereby incorporated by reference herein.

### COPYRIGHT NOTICE

A portion of the disclosure of this patent document contains material which is subject to copyright protection. The copyright owner has no objection to the facsimile reproduction by any-one of the patent document or the patent disclosure, as it appears in the Patent and Trademark Office patent file or records, but otherwise reserves all copyright rights whatsoever.

### BACKGROUND

Technology and commercial practices with respect to electronic media files, particularly in the e-book industry are causing fragmentation. This fragmentation is confusing for general end-users and limits the potential growth of the industry as a whole. E-book users, for example, generally lack the understanding and tools to properly store and consume their e-book content on various devices across a variety of e-book formats. Further, companies invested in electronic media file (e.g., e-book) ecosystems (e.g., publishers, retailers, and technology providers) lack the data aggregation tools required to grow the industry to its full potential.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a flow diagram of a method according to some embodiments;

FIG. 3 is a flow diagram of a method according to some embodiments

FIG. 4 is a block diagram of a system according to some embodiments;

FIG. 5 is a diagram of an example data storage structure according to some embodiments;

FIG. 6 is a flow diagram of a method according to some embodiments;

FIG. 7A and FIG. 7B are example interfaces according to some embodiments;

FIG. 8 is a block diagram of an apparatus according to some embodiments; and

FIG. 9A, FIG. 9B, FIG. 9C, and FIG. 9D are perspective diagrams of example data storage devices according to some embodiments.

### DETAILED DESCRIPTION

### I. Introduction

Embodiments described herein are descriptive of systems, apparatus, interfaces, methods, and articles of manufacture for media file management. In some embodiments, for example, data descriptive of electronic media files (e.g., e-books, video, and/or audio files) may be searched, scanned, looked-up, and/or otherwise acquired. In some embodiments, such data may be utilized to determine an authenticity and/or availability of a particular media file. Digital Rights Management (DRM) and/or other related files and/or information (e.g., metadata) may be analyzed, for example, to determine a likelihood or probability that a particular media file is (i) available and/or accessible and/or (ii) authentic (e.g., not copied, not copied illegally, and/or otherwise properly owned and/or possessed). According to some embodiments, the likelihood of a media file being available and/or authentic may be utilized to select and/or provide content to a user such as one or more advertisements, rewards and/or promotions (e.g., from a third-party).

Systems, method, articles of manufacture and/or interface in accordance with embodiments described herein may provide many benefits such as, but not limited to:
1. A simple and consistent interface for users to manage and access their e-book (and/or other media file) collection independent of format or source from which they acquire their e-book (and/or other media file) content;
2. A mechanism for the user to create a structured backup of their e-book (and/or other media file) content on their local computer (hard drive), external memory (hard drive, flash drive, CD backup, etc.), cloud drive(s) (and/or other network storage devices) and, “smart” access to their e-book (and/or other media file) content based on the suitability of the device currently accessing the content;
3. A scoring system that measures the “authenticity” of each e-book (and/or other media file; e.g., on a user's device(s), media file library, user, and/or user's account) based on data captured locally and/or data provided by third-parties including publishers, retailers, and digital fulfillment providers;
4. A direct marketing platform that utilizes the combination of authenticity scoring and the user's e-book (and/or other media file) content to target users for online/email/offline advertising based on their e-book (and/or other media file) collections, devices, and other aggregated user information;
5. A reporting platform for publishers, retailers and other interested third-parties to learn about the devices and e-books (and/or other media files) in a user's collection that may span multiple retailers, formats, and/or tracking/DRM technologies; and/or
6. A “news” feed delivery system to allow third-parties to advertise to users (e.g., e-book users) and for users to choose the type of “news” they receive based on their preferences and analysis of their e-book (and/or other media file) collection(s). News feeds may take the form of, but are not limited to, new title release dates, discounts, special promotions, and book events. Sources of these news feeds will include, but are not limited to, publishers, retailers, other third-party advertisers, and survey companies.

### II. Embodiments

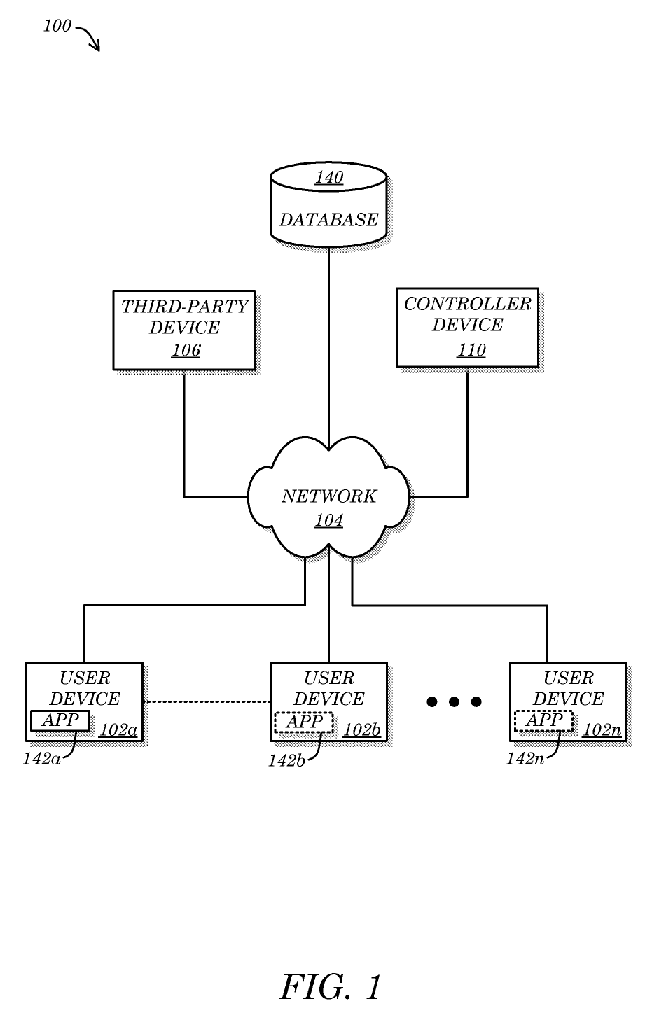

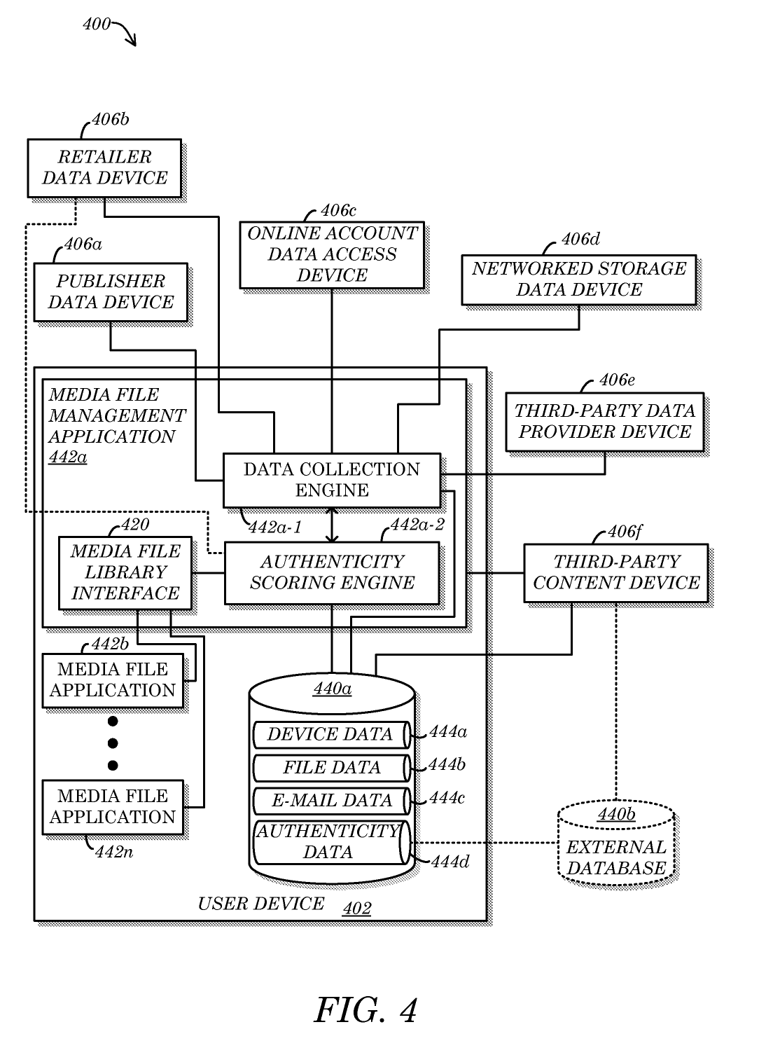

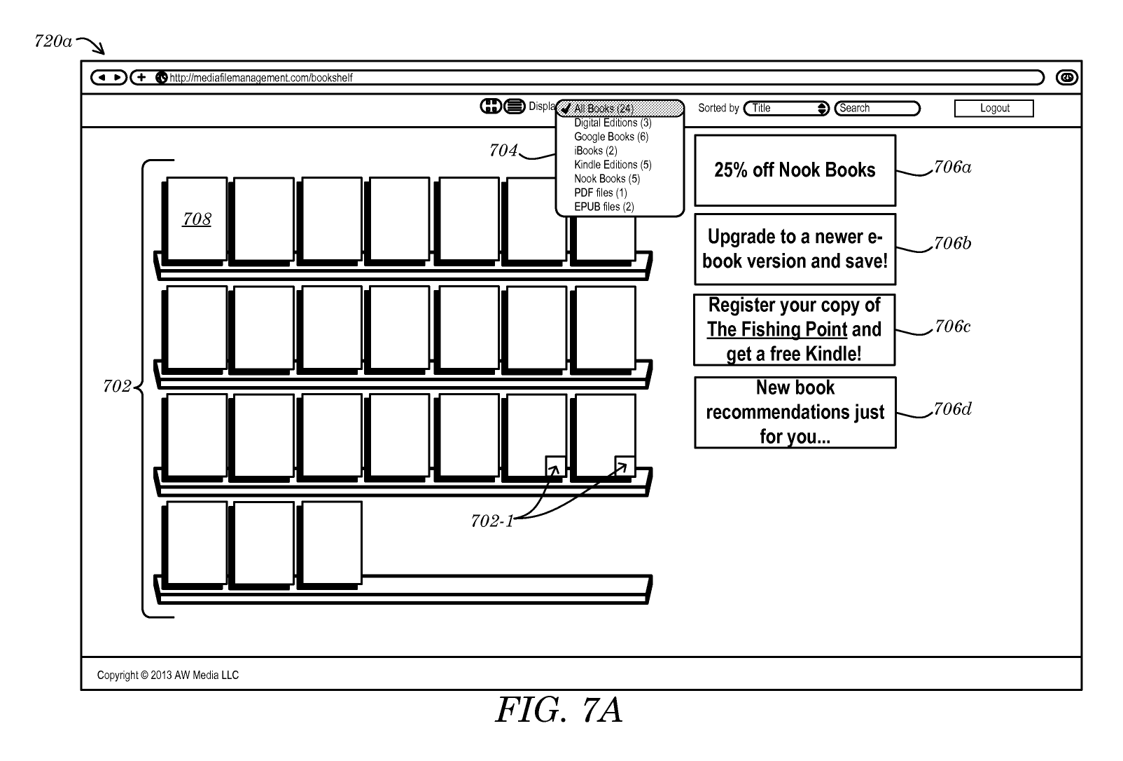

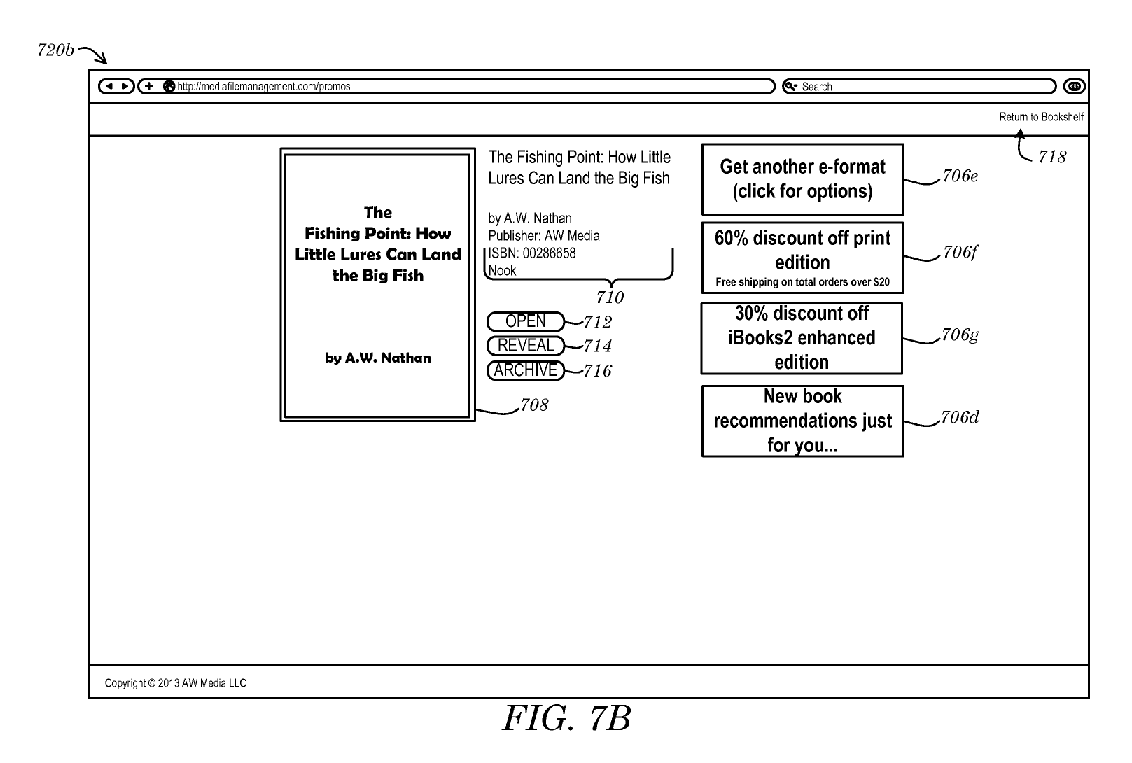

Referring first to FIG. 1, a block diagram of a system 100 according to some embodiments is shown. In some embodiments, the system 100 may comprise a plurality of user devices 102a-n, a network 104, a third-party device 106, a controller device 110, and/or a database 140. In some embodiments, any or all of the user device 102a-n may comprise and/or be associated with an application 142a-n. As depicted in FIG. 1, any or all of the devices and/or components 102a-n, 106, 110, 140, 142a-n (or any combinations thereof) may be in communication via the network 104. In some embodiments, the system 100 may be utilized to manage electronic media files as described herein. The controller device 110 and/or the applications 142a-n may, for example, interface with one or more of the user devices 102a-n to facilitate aggregation and/or acquisition of media file data, analyze, process, rank, and/or score the media file and/or related data, present an interface (e.g., the interfaces 420, 720a-b of FIG. 4, FIG. 7A, and/or FIG. 7B herein) via which a user may view and/or interact with media files of varying types, and/or provide (e.g., based on media file authenticity and/or availability data) targeted content, offers, and rewards to users (e.g., via one or more of the user devices 102a-n).

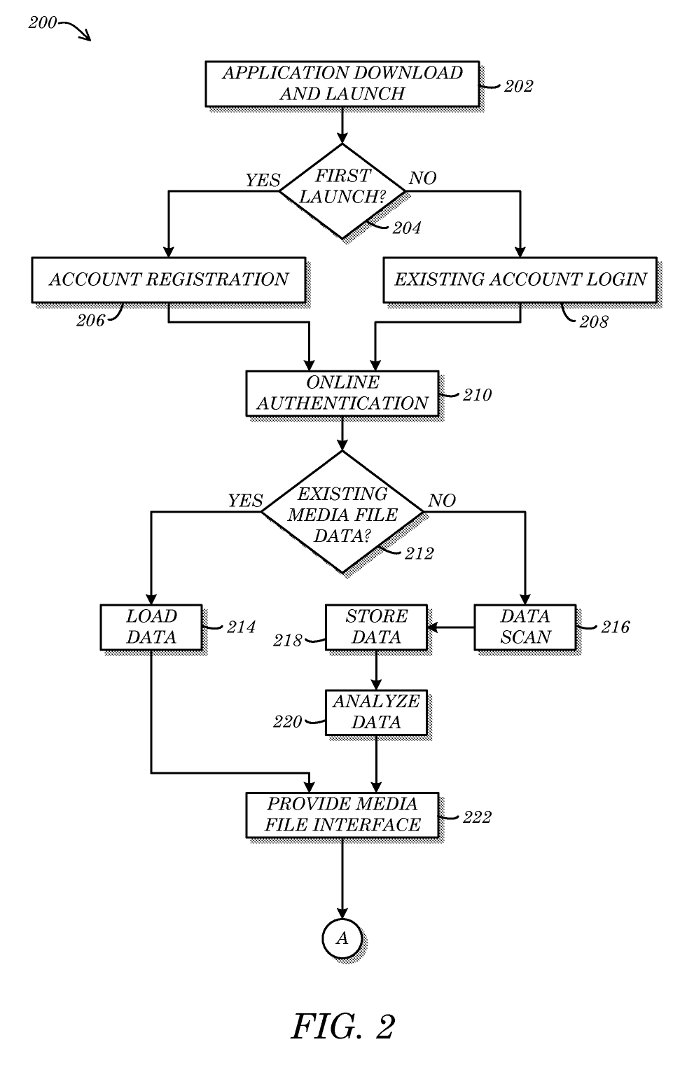

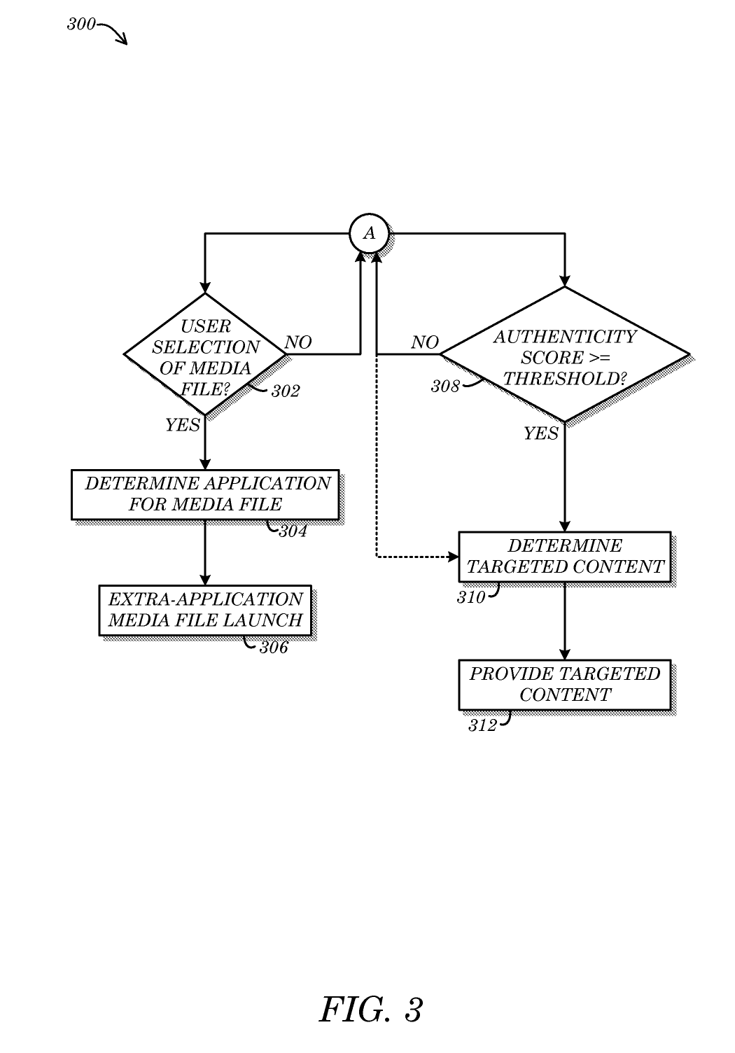

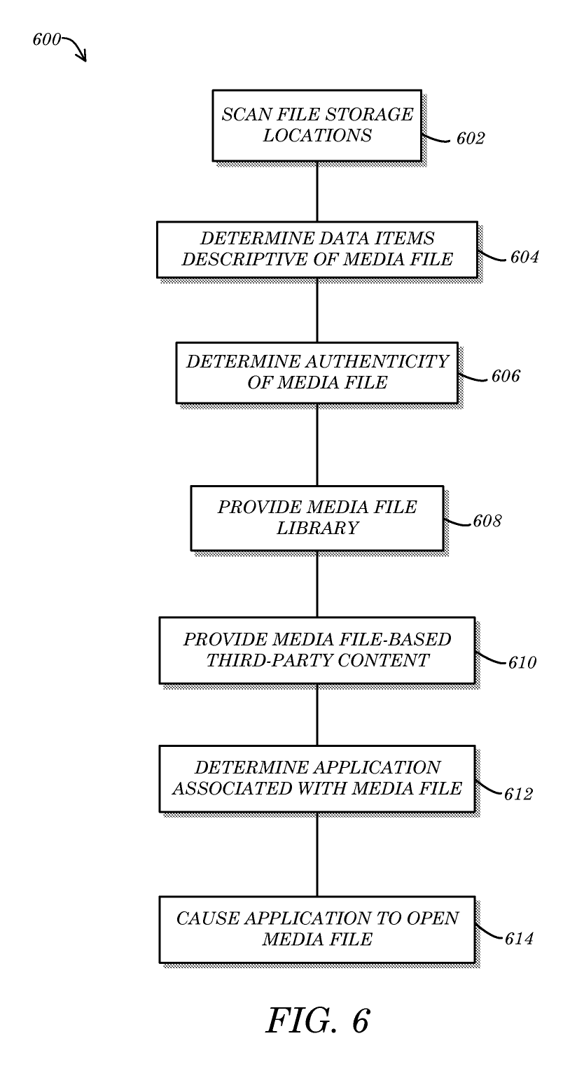

Fewer or more components 102a-n, 104, 106, 110, 140, 142a-n and/or various configurations of the depicted components 102a-n, 104, 106, 110, 140, 142a-n may be included in the system 100 without deviating from the scope of embodiments described herein. In some embodiments, the components 102a-n, 104, 106, 110, 140, 142a-n may be similar in configuration and/or functionality to similarly named and/or numbered components as described herein. In some embodiments, the system 100 (and/or portion thereof) may comprise a media file management program and/or platform programmed and/or otherwise configured to execute, conduct, and/or facilitate any of the various methods 200, 300, 600 of FIG. 2, FIG. 3, and/or FIG. 6 and/or portions or combinations thereof described herein.

The user devices 102a-n, in some embodiments, may comprise any types or configurations of computing, mobile electronic, network, user, and/or communication devices that are or become known or practicable. The user devices 102a-n may, for example, comprise one or more Personal Computer (PC) devices, computer workstations, network storage devices, servers, tablet computers such as an iPad® manufactured by Apple®, Inc. of Cupertino, Calif., and/or cellular and/or wireless telephones such as an iPhone® (also manufactured by Apple®, Inc.), an Optimus™ S smart phone manufactured by LG® Electronics, Inc. of San Diego, Calif., and running the Android® operating system from Google®, Inc. of Mountain View, Calif., or a device running a Microsoft® Windows® operating system such as Window® 8™ and/or Windows® RT™ platform. In some embodiments, the user devices 102a-n may comprise devices owned and/or operated by one or more customers, potential customers, user, and/or other consumers (none of which are explicitly shown). According to some embodiments, the user devices 102a-n may communicate with the controller device 110 via the network 104, such as to provide (and/or receive) data indicative and/or descriptive of one or more media files, and/or to participate in one or more promotional and/or rewards programs, each as described herein. In some embodiments, the user devices 102a-n may interface with the controller device 110 to effectuate communications (direct or indirect) with one or more other user devices 102a-n (such communication not explicitly shown in FIG. 1), such as may be operated by other users. In some embodiments, user devices 102a-n may communicate directly with other user devices 102a-n (e.g., a communication between a first user device 102a and a second user device 102b, as depicted via a dashed line in FIG. 1). According to some embodiments, the application(s) 142a-n may control, conduct, manage, and/or facilitate any or all such communications.

The network 104 may, according to some embodiments, comprise a Local Area Network (LAN; wireless and/or wired), cellular telephone, Bluetooth®, and/or Radio Frequency (RF) network with communication links between the controller device 110 and any or all of the user devices 102a-n. In some embodiments, the network 104 may comprise direct communications links between any or all of the components 102a-n, 106, 110, 140, 142a-n of the system 100. The user devices 102a-n may, for example, be directly interfaced or connected to one or more of the controller device 110, the third-party device 106, and/or the database 140 via one or more wires, cables, wireless links, and/or other network components, such network components (e.g., communication links) comprising portions of the network 104. In some embodiments, the network 104 may comprise one or many other links or network components other than those depicted in FIG. 1. The user devices 102a-n, for example, be connected to the controller device 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 106, 110, 140, 142a-n of the system 100. The network 104 may comprise one or more cellular telephone networks with communication links between the user devices 102a-n and the controller device 110, for example, and/or may comprise the Internet, with communication links between the controller device 110 and the third-party device 106, for example.

According to some embodiments, the third-party device 106 may comprise a network device such as a server owned and/or operated by and/or otherwise associated with a third-party entity (e.g., an entity other than an entity associated with the user devices 102a-n and/or the controller device 110). The third-party device 106 may, for example, comprise a merchant, manufacturer, publisher, and/or other provider of electronic media files such as e-books, movie files, television show files, audio books, and/or music files. In some embodiments, the user devices 102a-n may communicate with the third-party device 106 to purchase and/or otherwise acquire one or more media files. According to some embodiments, the third-party device 106 may comprise a device operable and/or configured to verify and/or manage DRM data, files, and/or file access information (e.g., operated by a third-party DRM service provider)—without compromising the security features of DRM.

In some embodiments, the controller device 110 may comprise an electronic and/or computerized controller device such as a computer server communicatively coupled to interface with the user devices 102a-n (directly and/or indirectly). The controller device 110 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the controller device 110 may be located remote from one or more of the user devices 102a-n. The controller device 110 may also or alternatively comprise a plurality of electronic processing devices located at one or more various sites and/or locations.

According to some embodiments, the controller device 110 may store and/or execute specially programmed instructions to operate in accordance with embodiments described herein. The controller device 110 may, for example, execute one or more programs (not explicitly depicted in FIG. 1) that aggregate, analyze, provide access to, process, and/or otherwise manage electronic media files (e.g., associated with a user of one or more of the user devices 102a-n). According to some embodiments, the controller device 110 may comprise a computerized processing device such as a PC, laptop computer, computer server, and/or other electronic device to manage and/or facilitate transactions and/or communications regarding the user devices 102a-n, the third-party device 106, and/or the database 140. An electronic media file management and/or reporting entity may, for example, utilize the controller device 110 to (i) scan, aggregate, analyze, and/or acquire information descriptive of one or more electronic media files, (ii) calculate and/or otherwise determine an availability and/or authenticity score or metric for one or more media files, (iii) provide and/or facilitate access to a plurality of media files of disparate types and/or formats (e.g., via a single interface and/or application—such as the application(s) 142a-n), (iv) cause and/or facilitate opening, launching, and/or execution or other utilization of one or more media files via various and/or disparate software programs and/or applications, and/or (v) provide incentives, rewards, substitutes, promotions, advertisements, news feeds, and/or other content to users (e.g., based on media file data such as availability and/or authenticity scores or metrics; in accordance with embodiments described herein).

In some embodiments, the controller device 110 may provide access to and/or operate in conjunction with the application(s) 142a-n. The controller device 110 may comprise server-side instructions and/or application data, for example, while the application(s) 142a-n comprise client-side instructions and/or application data. According to some embodiments, the controller device 110 may communicate with the application(s) 142a-n (e.g., via the user devices 102a-n) to cause, effectuate, implement, initiate, and/or facilitate embodiments described herein. The controller device 110 may, for example, provide access to allow downloading, installation, and/or verification of the application(s) 142a-n on the user devices 102a-n and/or manage and/or facilitate communications between the application(s) 142a-n (and/or user devices 102a-n) and one or more of the third-party device 106 and the database 140.

According to some embodiments, the database 140 may comprise any type, configuration, and/or quantity of data storage devices that are or become known or practicable. The database 140 may comprise, for example, a cache, RAM, hard drive, or other disk or storage medium (e.g., a computer-readable memory device) that stores various instructions and/or data. In some embodiments, the database 140 may comprise an array of optical and/or solid-state hard drives configured to store user, device, and/or media file data (e.g., received and/or provided by one or more of the user devices 102a-n, the third-party device 106, and/or the controller device 110) and/or various operating instructions, drivers, etc. While the database 140 is depicted as a stand-alone component of the system 100 in FIG. 1, the database 140 may comprise multiple components. In some embodiments, a multi-component database 140 may be distributed across various devices and/or may comprise remotely dispersed components. Any or all of the user devices 102a-n, the third-party device 106, and/or the controller device 110 may, for example, comprise the database 140 or a portion thereof. In some embodiments, the database 140 may be communicatively coupled any or all of the user devices 102a-n, the third-party device 106, and/or the controller device 110, as depicted. The database 140 may, in accordance with some embodiments, store one or more programs and/or other instructions that (e.g., when processed by a device such as the user devices 102a-n, the third-party device 106, and/or the controller device 110, and/or any combinations thereof) cause implementation and/or facilitation of, in whole or in part, any of the methods, processes, and/or procedures as described herein (e.g., the methods 200, 300, 600 of FIG. 2, FIG. 3, and/or FIG. 6 herein, and/or portions and/or combinations thereof).

In some embodiments, the application(s) 142a-n may comprise one or more software, firmware, and/or hardware components configured to allow the user devices 102a-n to manage electronic media files. The application(s) 142a-n may, for example, provide a single program and/or interface via which media files of different types and/or formats may be viewed, managed, and/or analyzed. According to some embodiments, the application(s) 142a-n may communicate with any or all of the user devices 102a-n, the third-party device 106, the controller device 110, and/or the database 140, such as to acquire information descriptive of media files associated with a user and/or respective user device 102a-n. In some embodiments, the application(s) 142a-n may communicate with other components 102a-n, 106, 110, 140 to retrieve and/or provide targeted content to and/or via the user devices 102a-n.

Referring now to FIG. 2, a flow diagram of a method 200 according to some embodiments is shown. In some embodiments, the method 200 may be performed and/or implemented by and/or otherwise associated with one or more specialized and/or computerized processing devices (e.g., the user devices 102a-n, 402, the controller device 110, and/or the application 142a-n, 442a of FIG. 1 and/or FIG. 4 herein), specialized computers, computer terminals, computer servers, computer systems and/or networks, and/or any combinations thereof. According to some embodiments, the method 300 may be implemented, facilitated, and/or performed by or otherwise associated with the systems 100, 400 of FIG. 1 and/or FIG. 4 herein. In some embodiments, the method 200 may be embodied in, facilitated by, and/or otherwise associated with various input mechanisms and/or interfaces (e.g., the interfaces 420, 720a-b of FIG. 4, FIG. 7A, and/or FIG. 7B herein) such as may be provided by and/or on any or all of the devices described herein. In some embodiments, the method 200 may comprise and/or otherwise be associated with one or more of the methods 300, 600 of FIG. 3 and/or FIG. 6 herein, and/or one or more portions or combinations thereof.

The process and/or flow diagrams described herein do not necessarily imply a fixed order to any depicted actions, steps, and/or procedures, and embodiments may generally be performed in any order that is practicable unless otherwise and specifically noted. Any of the processes and/or methods described herein may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described herein.

In some embodiments, the method 200 may comprise downloading and/or launching a first application, at 202. An electronic media file management application (e.g., the application(s) 142a-n of FIG. 1) may, for example, be transferred from a first computer-readable memory (e.g., of a server, removable disk, and/or removable storage device) to a second computer-readable memory (e.g., of a user device such as a mobile electronic device). According to some embodiments, the downloading may be initiated, controlled, managed, and/or facilitated by a server such as the controller device 110 of FIG. 1. A user may create and/or login to an account with the server, via a web interface for example, and request, purchase, and/or otherwise obtain rights to a copy of the application. In some embodiments, the application may be marketed as and/or comprise an application that allows a user to view and manage, launch, open, and/or execute, receive third-party content related to, and/or otherwise utilize one or more libraries of media files. In some embodiments, the downloading and/or launching or execution of the application may be conducted by a user device (and/or server device) in response to a request for downloading and/or execution received from a user (e.g., via a user device). In some embodiments, the launching may comprise a server device causing an initiation of an executable file on and/or at a user device.

According to some embodiments, the method 200 may comprise determining whether the launch of the application comprises a first instance of a launch of the application, at 204. The application may, for example, access one or more files to determine if the application has previously been executed on a particular device and/or with respect to a particular user and/or user account. In the case that it is determined that the application is being launched for the first time, the method 200 may proceed to 206. In some embodiments for example, the method 200 may comprise determining an account registration, at 206. A user may provide registration information to establish an account with and/or via a server device, for example, and/or may be provided with Terms Of Service (TOS) and/or an End-User License Agreement (EULA) regarding the application. In some embodiments, indications of acceptance of such TOS and/or EULA terms may be received from the user and/or user device. According to some embodiments, the registration may comprise receiving user data, user device data, and/or media file data from the user (e.g., at and/or via a server device and/or via the application). The user may provide (and/or a server and/or other processing device may receive) indications of the user's name, address (e.g., street, city, state, country, zip code or other postal code), electronic contact information (e.g., e-mail, Facebook® and/or other social media contact information), demographic information, device information (e.g., explicitly entered and/or automatically obtained from the user's device(s)—with the user's consent), and/or user preference information (e.g., preferred media file types, storage locations, programs or applications to utilize to access media files, preferred devices, preferred retailers, publishers, etc.). In some embodiments, once the desired information has been received and/or the account is setup, the method 200 may proceed to 210.

According to some embodiments, in the case that the determination at 204 indicated that the application has been previously launched and/or that the user has an existing account, the method 200 may proceed to 208. In some embodiments for example, the method 200 may comprise facilitating an account login, at 208. The application, a user device, and/or a server device associated therewith may, for example, receive login credentials from a user. According to some embodiments, receipt of the login credentials may cause the method 200 to proceed to 210.

In some embodiments, the method 200 may comprise online account authentication, at 210. Credentials received at 208 and/or information received at 206 may, for example, be processed and/or analyzed (e.g., compared to stored information) to determine whether the user's account is authentic, active, in good status, etc. In the case that the authentication and/or verification results in a determination that the account is not valid or active, the method 200 may revert back to 206 or 208 and/or may otherwise interface with the user and/or application to facilitate initialization of the application. In the case that the authentication and/or verification results in a determination that the account is valid, the method 200 may proceed to 212.

According to some embodiments, the method 200 may comprise determining whether stored media file data exists, at 212. In the case that the application has been previously been activated and/or launched, for example, or in the case that the user's account has previously been utilized in connection with media file management, data relating thereto may already be stored (e.g., in a database such as the database 140, 440a-b of FIG. 1 and/or FIG. 4 herein). In some embodiments, the application may store a flag and/or pointer descriptive of any previous data gathering and/or storage activities associated with the application and/or user account. According to some embodiments, the application may search for existing data (e.g., in one or more default locations, such as on or at a server or cloud storage device) to determine whether stored data already exists (or not). In the case that it is determined that stored media file data already exists, the method 200 may proceed to 214.

In some embodiments, the method 200 may comprise loading media file data, at 214. The application may load media file data from one or more local (e.g., user device) libraries, folders, files, and/or other storage structures, for example, and/or may search, lookup, and/or load data stored in one or more remote locations (e.g., third-party data, server-side data, cloud storage data, etc.). According to some embodiments, once some or all (e.g., selected portions) of the stored data is loaded and/or accessed, the method 200 may proceed to 220 (e.g., to analyze or re-analyze the stored data and/or portions thereof) and/or 222.

In the case that it is determined that stored media file data does not already exists, the method 200 may proceed to 216. According to some embodiments for example, the method 200 may comprise initiating a data scan, at 216. In some embodiments, the data scan at 216 may be initiated even if stored data is found and/or know to exist. The data scan may, for example, be initiated at 216 to supplement data already stored and/or loaded at 214. According to some embodiments, the data scan may comprise a search for files, images, e-mails, and/or other data (e.g., transaction data such as credit card, bank, and/or financial software data). The application may, for example, search for (i) device data (e.g., hardware identifiers, MAC address, software and/or applications installed, and/or any versions or update information thereof), (ii) user third-party account data, (iii) media files, and/or (iv) data related to availability and/or authenticity of the media files (e.g., media file metadata, transaction and/or fulfillment information, browsing history, and/or DRM information). According to some embodiments, the scope and/or focus of the search and/or scan may be determined by and/or based on the number and/or type of media files associated with the user, user's account, and/or user device. Media files of a first type, for example, may be known to have associated DRM information stored in a particular directory, having files of a particular file extension and/or name, and/or available online (e.g., via a publisher, retailer, and/or third-party DRM service). In the case that a media file of the first type is located and/or identified, the scan and/or search may initiate logic and/or rules specific to that file type—e.g., the scan may comprise a search for the known location, type, and/or name of associated DRM data for the first type of media file.

In some embodiments, the method 200 may comprise storing the media file data, at 218. Any or all information retrieved and/or identified by the scan at 216, for example, may be stored and/or referenced. According to some embodiments, scan results may be stored as one or more indicators of determinations and/or flags. In the case that a DRM file for a particular type of media file is searched for at 216 and located, for example, a flag and/or other data may be stored indicating that the appropriate DRM file was found (e.g., as opposed to storing, copying, and/or otherwise manipulating the file itself). In some embodiments, identified files and/or contents thereof may be stored and/or locations thereof noted, flagged, and/or indexed.

According to some embodiments, the method 200 may comprise analyzing the media file data, at 220. Scanned, stored, loaded, acquired, and/or accessed media file information may, for example, be processed by the application, user device, and/or server to determine various metrics, statistics, and/or parameter values. The data may be analyzed, in some embodiments, to determine various reporting metrics and/or statistics regarding media files associated with the user, user account, and/or user device. Information such as the user's favorite genre of e-book and/or music, the most prevalent type of media file (e.g., how many Nook® books the user owns as opposed to iBooks®), statistics regarding the user's access to various media files (e.g., how often the user listens to a particular song, artist, etc., and/or how long it has been since the user accessed an unfinished e-book), etc., may be determined from the media file data and/or provided to one or more third-parties (e.g., marketing entities, publishers, etc.). According to some embodiments, the analyzing of the media file data may comprise determining one or more metrics regarding an availability and/or authenticity of a media file. It may be determined, for example, whether all necessary files and/or data (e.g., DRM data) for a particular media file have been located. This may inform, for example, regarding whether the media file is likely available for utilization or whether the file is corrupt and/or otherwise defective (e.g., “unavailable”). According to some embodiments, the media file data may be analyzed to determine an authenticity of a media file. It may be determined, for example, whether DRM information for a media file is located, whether transaction data for a purchase of the media file is located, and/or whether other indicators of how likely a media file is to have been legitimately acquired as opposed to being “suspect” and/or questionably acquired, have been located.

In some embodiments, the method 200 may comprise providing an media file interface, at 222. The application may cause an outputting, via a user device for example, of a media file management interface such as an e-book “bookshelf”—e.g., the interfaces 420, 720a-b of FIG. 4, FIG. 7A, and/or FIG. 7B herein. The interface may, for example, provide the user with access to view any or all media files associated with the user, e.g., regardless of type and/or compatibility, via a single application/interface. According to some embodiments, only those media files having been analyzed (e.g., at 220) as having an availability and/or authenticity metric above a predetermined threshold may be provided to the user via the interface. In some embodiments, media files not meeting one or more threshold requirements of availability and/or authenticity may be presented via the interface, but may be ‘grayed-out’ or otherwise indicated as having issues, and/or may generally be un-executable (e.g., even via one or more secondary or external applications). In some embodiments, the interface may allow the user to select and/or interact with media files and/or related data and/or receive and/or access content targeted to the user (e.g., targeted advertisements, promotions, etc.). The method 200 may, for example, be passed to and/or otherwise utilized by a separate, related, and/or continued process via the node labeled “A” in FIG. 2.

Turning to FIG. 3, for example, a flow diagram of a method 300 (that may initiate at the node labeled “A”) according to some embodiments is shown. In some embodiments, the method 300 may be performed and/or implemented by and/or otherwise associated with one or more specialized and/or computerized processing devices (e.g., the user devices 102a-n, 402, the controller device 110, and/or the application 142a-n, 442a of FIG. 1 and/or FIG. 4 herein), specialized computers, computer terminals, computer servers, computer systems and/or networks, and/or any combinations thereof. According to some embodiments, the method 300 may be implemented, facilitated, and/or performed by or otherwise associated with the systems 100, 400 of FIG. 1 and/or FIG. 4 herein. In some embodiments, the method 300 may be embodied in, facilitated by, and/or otherwise associated with various input mechanisms and/or interfaces (e.g., the interfaces 420, 720a-b of FIG. 4, FIG. 7A, and/or FIG. 7B herein) such as may be provided by and/or on any or all of the devices described herein. In some embodiments, the method 300 may comprise and/or otherwise be associated with one or more of the methods 200, 600 of FIG. 2 and/or FIG. 6 herein, and/or one or more portions or combinations thereof.

In some embodiments, the method 300 may comprise determining a user selection of a media file, at 302. The application, user device, and/or server may receive, for example, an indication that a user has selected a media file (e.g., via the interface provided at 222 of FIG. 2). In the case that such an indication is received and/or it is otherwise determined that the user desires to activate and/or utilize a media file, the method 300 may progress to 304. According to some embodiments for example, the method 300 may comprise determining an application associated with the selected media file, at 304. The media file management application (e.g., a first application) may, for example, lookup and/or otherwise determine one or more other applications or programs (e.g., one or more second applications) via which a media file can be opened and/or executed. In some embodiments, such as in the case that multiple applications may be capable of opening a media file, a default (e.g., chosen by the application) and/or preferred (e.g., preferred by the user and/or one or more third-parties) application may be selected to be associated with the media file and/or media file type.

In some embodiments, the method 300 may comprise causing an extra-application launch of the media file, at 306. The one or more second applications determined and/or selected at 304, for example, may be initialized, called, and/or otherwise activated to open the selected media file. In some embodiments, the media file and/or information thereof (e.g., location and/or DRM information) may be transmitted to the second application (e.g., from the first application). According to some embodiments, the second application may be installed and/or resident on the same device as the first application. In some embodiments, the second application may comprise an application executed on different and/or remote device. In such a manner, for example, media files of varying types and/or formats may be managed from the single (e.g., first) application by utilizing the single application as a launching point for other applications configured to play and/or execute the desired media files. In some embodiments, such as in the case that a media file comprises an open-source and/or unprotected or common type (e.g., a PDF or EPUB file), the first application may be configured to launch and/or access the media file without requiring communication with and/or utilization of any extra-application programs or hardware.

According to some embodiments, the method 300 may comprise determining if a metric associated with one or more media files is greater than a predetermine threshold, at 308. One or more of an availability and authenticity metric for a media file (e.g., determined at 220 of FIG. 2) may, for example, be ranked, graphed, and/or otherwise compared and/or contrasted to one or more thresholds and/or other scores/ranks/metrics to determine whether targeted content should be delivered to the user, user account, user device, and/or application. In some embodiments, the determination of whether to provide content may be conducted by a third-party such as a marketing entity, retailer, publisher, etc. In the case that the media file data is determined to warrant targeted content, the method 300 may progress to 310. According to some embodiments, the media file (and/or user or user account) may be deemed to warrant targeted content based on the availability/authenticity score or metric. In the case that the score is determined to be greater than the threshold, for example, it may be determined that targeted content should be provided and the method 300 may progress to 310. According to some embodiments (such as depicted by the dashed line in FIG. 3), the method 300 may progress to 310 in the case that the score does not meet or exceed the threshold. In the case that a media file, media library, user, and/or user account is scored lowly enough to be considered “suspect”, for example, it may be desirable to target certain content to such a user/user's device—e.g., to progress the user on a path toward achieving a higher score such as by providing access to transaction records, consummating a purchase, etc.

In some embodiments for example, the method 300 may comprise determining targeted content, at 310. The determining of the targeted content may be conducted by the application, a third-party, and/or by a server device. One or more third-parties offering content such as advertisements and/or promotions, for example, may indicate (or decide) that certain content should be provided to users in certain situations regarding media file scoring, ranking, etc. In the case that a user is believed to have a plurality of unavailable (e.g., corrupt, mismanaged, fragmented) media files, for example, it may be desirable to provide the user with an offer to remediate the user's issues—e.g., making the user's media files whole, repairing them, re-downloading them, etc. In the case that a user's media files (or some portion or even specific items thereof) score above a certain threshold (e.g., above a ninety percent (90%) confidence level that a media file has been legitimately acquired), in some embodiments, special offers such as discounts, early access to and/or pre-releases of new media files, substitutes, upgrades and/or enhanced versions of media files may be provided—e.g., as a reward for the user being an authenticated customer.

According to some embodiments, the method 300 may comprise providing the targeted content, at 312. Content chosen, selected, identified, and/or otherwise determined at 310, for example, may be output to the user via the application (and/or via the interface thereof). In some embodiments, the content may be provided via one or more hyperlinks and/or other location identifiers appended to and/or embedded in an interface utilized by the user. Content may be downloaded to a user device (e.g., an electronic coupon, ticket, voucher, etc.) or may be accessible via the user device (e.g., via access to one or more specific websites and/or online files).

Referring now to FIG. 4, a block diagram of a system 400 according to some embodiments is shown. The system 400 may comprise, for example, a user device 402, one or more third-party devices 406a-f, a media file library interface 420, one or more databases 440a-b (e.g., an internal database 440a and/or an external database 440b), a media file management application 442a (e.g., comprising a data collection engine 442a-1 and/or an authenticity scoring engine 442a-2; e.g., a first application), one or more media file applications 442b-n (e.g., second or secondary applications), and/or various stored data 444a-d (e.g., device data 444a, file data 444b, e-mail data 444c, and/or authenticity data 444d). Fewer or more components 402, 406a-f, 440, 440a-b, 442a-n, 444a-d and/or various configurations of the depicted components 402, 406a-f, 440, 440a-b, 442a-n, 444a-d may be included in the system 400 without deviating from the scope of embodiments described herein. In some embodiments, the components 402, 406a-f, 440, 440a-b, 442a-n, 444a-d may be similar in configuration and/or functionality to similarly named and/or numbered components as described herein. In some embodiments, the system 400 (and/or a portion thereof) may comprise a media file management system, program, and/or platform programmed and/or otherwise configured to execute, conduct, and/or facilitate any of the various methods 200, 300, 600 of FIG. 2, FIG. 3, and/or FIG. 6 and/or portions or combinations thereof described herein.

In some embodiments, the user device may comprise a mobile electronic device such as a wireless telephone, smart phone, tablet computing device, etc. According to some embodiments, the media file management application 442a may be installed on the user device 402 and/or may utilize the data collection engine 442a-1 to scan and/or search for data related to electronic media files. The data collection engine 442a-1 may, for example, communicate with any or all of the third-party devices 406 to search for and/or retrieve data descriptive of one or more media files associated with the user device 402 (and/or a user and/or user account thereof—not explicitly shown).

In some embodiments, the data collection engine 442a-1 may obtain data from the publisher data device 406a. Publisher data may comprise, for example, data descriptive of e-book and/or other media file titles, availability and/or release dates, versions, special offers from the publisher, etc. According to some embodiments, the data collection engine 442a-1 may obtain data from the retailer data device 406b. Retailer data may comprise, for example, sales receipts, fulfillment data, DRM data, inventory data, retailer promotions, etc.

In some embodiments, the data collection engine 442a-1 may obtain data from the online account data access device 406c. Online account information may comprise, for example, online account login credential information (e.g., for one or more online media file-related accounts such as an iTunes®, Nook®, and/or Amazon® Prime account) and/or information obtained by logging into one or more online accounts. The data collection engine 442a-1 may, for example, utilize a user's online account credentials to log into one or more of the user's accounts (via the online account data access device 406c) and obtain media file-related data such as online media file library information, media file purchase information, and/or DRM data.

According to some embodiments, the data collection engine 442a-1 may obtain data from the networked storage data device 406d. Various types of media file-related information may, for example, be acquired from and/or the networked data storage device 406d may comprise, one or more network storage devices accessible via the user device 402 (e.g., a networked hard drive, server, media server, cloud storage device, etc.). The data collection engine 442a-1 may, for example, search all networked drives and/or locations associated with a user (and/or the user device 402) to retrieve media file library information (e.g., to construct and/or determine a library of media files belonging to the user).

In some embodiments, the data collection engine 442a-1 may obtain data from the third-party data provider device 406e. The third-party data provider device 406e may comprise, for example, a device operated by a third-party data service that may provide demographic information, credit card and/or financial institution information (e.g., purchase transaction records), and/or other data descriptive of the user, the user device 402, an account of the user, and/or one or more media files associated with the user.

According to some embodiments, the data collection engine 442a-1 may obtain data from the internal database 440a. The internal database 440a may, for example, store the device data 444a, the file data 444b, and/or the e-mail data 444c. In some embodiments, the device data 444a may comprise data descriptive of the user device 402 and/or other user devices (not shown) associated with the user. Such information may include, for example, MAC address and/or identifier data, manufacturer, model, and/or serial number data, sim card data, network access data (e.g., protocols and/or drivers), and/or device capability data (e.g., electronic storage sizes, partitions, file and/or folder structures, device features, and/or device performance data). In some embodiments, the file data 444b may comprise data descriptive of and/or comprising one or media files. The file data 444b may comprise, for example, one or more e-book, music, movie, TV episode, audio book, newspaper and/or news feed, and/or other media file content data. According to some embodiments, the e-mail data 444c may comprise data descriptive of one or more transaction receipts and/or confirmations associated with a media file. The e-mail data 444c may, for example, comprise an electronic receipt e-mailed from an online media file vendor to the user, which may comprise a listing and/or other data (e.g., pricing and/or DRM data such as an access and/or authentication or activation code) descriptive of one or more purchased media files.

In some embodiments, data obtained by the data collection engine 442a-1 (e.g., upon installation and/or execution of the media file management application 442a—such as once upon install, every time a launch occurs, and/or on-demand such as per a user request) may be provided and/or passed to the authenticity scoring engine 442a-2. The authenticity scoring engine 442a-2 may, for example, analyze any or all retrieved and/or identified data (e.g., at 220 of FIG. 2) to determine one or more availability and/or authenticity metrics, parameters, and/or scores associated with a user's identified media files. The scoring may comprise, in accordance with some embodiments, determining an amount, quality, correspondence, and/or availability (or existence or non-existence) of various data. The scoring may, for example, result in an assignment of a qualitative identifier to an account, user, device, media file, and/or library of media files—e.g., “Verified”, “Highly Likely”, “Likely”, “Suspect”, and/or “Non-Verifiable”. In some embodiments, the authenticity scoring engine 442a-2 may store and/or update the authenticity data 444d in the internal database 440a and/or in the external database 440b (e.g., cloud storage and/or a data store accessible to the third-party content device 406f). In some embodiments, the authenticity scoring engine 442a-2 may require and/or utilize external data to verify and/or score one or more media files, media libraries, users, user accounts, etc. As depicted by the dashed line in FIG. 4, for example, the authenticity scoring engine 442a-2 may connect directly to a third-party device 406a-f such as the retailer data device 406b—e.g., to obtain on-demand transaction data. In some embodiments, the authenticity scoring engine 442a-2 may acquire any desired and/or necessary third-party data via the data collection engine 442a-1 (e.g., by requesting the data collection engine 442a-1 initiate a scan, data pull, etc.).

According to some embodiments, any media files determined to be available and/or authentic by the authenticity scoring engine 442a-2 may be provided and/or passed to the media file library interface 420. The media file library interface 420 (e.g., a virtual bookshelf such as the example interfaces 720a-b of FIG. 7A and/or FIG. 7B herein) may, for example, provide (e.g., via the media file management application 442a) a Graphical User Interface (GUI) via which a user of the user device 402 may view, retrieve information regarding, manage (e.g., edit metadata, add, delete, upgrade, purchase, substitute and/or replace), and/or cause an opening of a plurality of media files such as e-books, to which the user has access.

In some embodiments, the media file library interface 420 may permit the user to launch one or more of the media file applications 442b-n from within and/or via the media file management application 442a. The media file management application 442a may, for example, receive an indication of a user selection of a media file represented by the media file library interface 420 (e.g., at 302 of FIG. 3) and determine which of the media file applications 442b-n should be utilized to provide access to the selected media file (e.g., at 304 of FIG. 3). In some embodiments, the media file management application 442a may send a signal to one or more of the media file applications 442b-n and/or to or via an Operating System (OS) of the user device 402 that causes the one or more of the media file applications 442b-n to open the selected file (e.g., at 306 of FIG. 3).

According to some embodiments, the third-party content device 406f may provide content targeted to the user via the media file management application 442a (and/or via the media file library interface 420 thereof). The third-party content device 406f may be utilized, for example, to determine whether targeted content should be provided (e.g., at 308 of FIG. 3) and/or determine which available content should be provided (e.g., at 310 of FIG. 3). In the case that the third-party content device 406f comprises an advertisement and/or promotional server, for example, the third-party content device 406f may utilize authenticity data 444d (and/or other media file-related data) to determine whether one or more advertisements and/or promotions should be output to the user (e.g., via the user device 402). In some embodiments, one of a plurality of available advertisements, promotions, and/or rewards may be selected based on an authenticity score for one or more media files associated with the user. Differing content and/or pricing may be available and/or provided, for example, in each qualitative authenticity scoring identifier/metric.

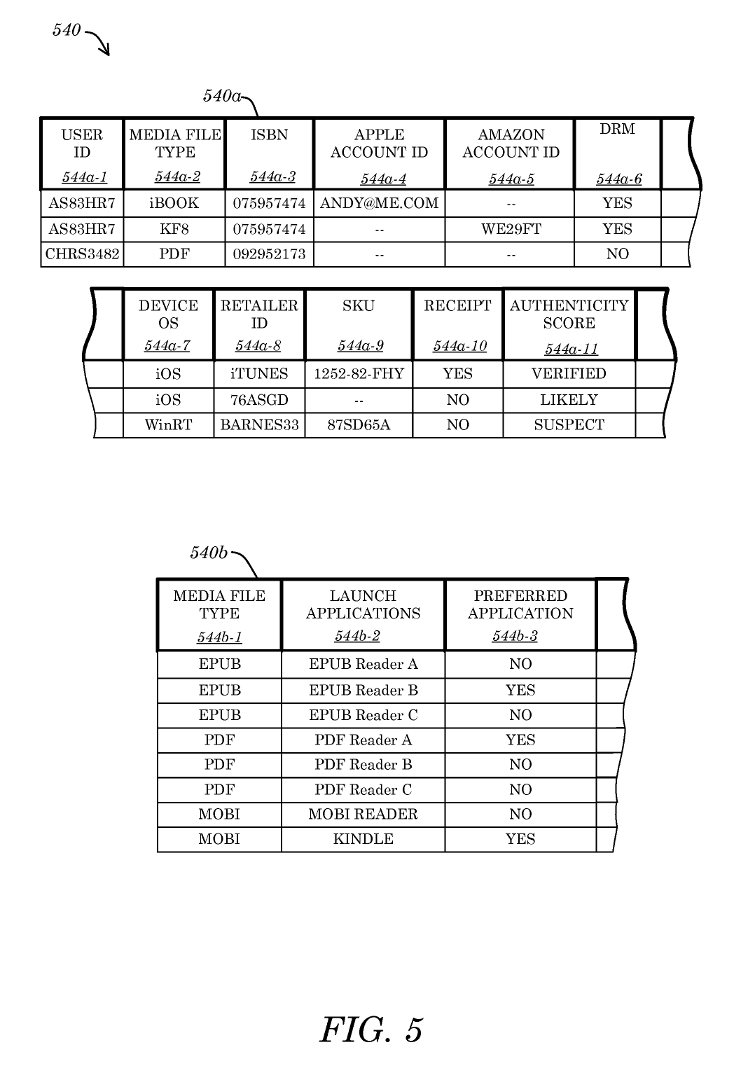

Turning to FIG. 5, a diagram of an example data storage structure 540 according to some embodiments is shown. In some embodiments, the data storage structure 540 may comprise one or more data tables such as a media file table 544a and/or a media type table 544b. The data table(s) 544a-b may, for example, be utilized to store media file, user, device, DRM, and/or transaction data to facilitate media file management and/or targeted content delivery, as described herein.

The media file table 544a may comprise, in accordance with some embodiments, a user IDentifier (ID) field 544a-1, a media file type field 544a-2, an ISBN field 544a-3, an Apple® account ID field 544a-4, an Amazon® account ID field 544a-5, a DRM field 544a-6, a device OS field 544a-7, a retailer ID field 544a-8, a SKU field 544a-9, a receipt field 544a-10, and/or an authenticity score field 544a-11.

The ID fields 544a-1, 544a-4, 544a-5, 544a-8 may generally store any type of identifier that is or becomes desirable or practicable (e.g., a unique identifier, an alphanumeric identifier, and/or an encoded identifier). The user ID field 544a-1 may, for example, uniquely identify a particular user and/or customer and/or comprise one or more coded (and/or encrypted) indications such as indicia of a group to which the user belongs (e.g., a company and/or organization).

The media type field 544a-2 may, in some embodiments, store an indicator descriptive of a type, format, publisher, and/or compatible device information for a particular media file. According to some embodiments, the ISBN field 544a-3 may store an indicator of an ISBN and/or other publication identifier, the DRM field 544a-6 may store information descriptive of one or more DRM codes, hash tags, and/or other encoding and/or encryption/decryption data, and/or the device OS field 544a-7 may store an indicator of an OS type, manufacturer, version, service pack, etc., associated with a particular user device. In some embodiments, the SKU field 544a-9 may store information descriptive of a stock identifier of a media file and/or the receipt field 544a-10 may store an indication of whether a receipt for a media file is acquired and/or data descriptive of such a receipt. According to some embodiments, the authenticity score field 544a-11 may store an indication of one or more of an availability and/or authenticity metric, score, rank, and/or flag or label, e.g., as determined and/or utilized herein.

The media type table 540b may comprise, in accordance with some embodiments, a media file type field 544b-1, a launch application field 544b-2, and/or a preferred application field 544b-3. The media file type field 544b-1 may, for example, store an indication of a type, format, and/or manufacturer/owner of a particular media file type while the launch application field 544b-2 may store an indication of one or more known and/or available types of media file readers, applications, etc. In some embodiments, the applications listed in the launch application field 544b-2 may comprise applications identified as being resident on one or more devices associated with a user and/or user account. According to some embodiments, the preferred application field 544b-3 may store an indication of one or more default and/or preferred software and/or application packages capable of utilizing (e.g., opening, editing, launching, and/or executing) a media file of the given type. In some embodiments, the preferred application field 544b-3 may be populated and/or determined by default (e.g., either due to only a single launch application being available and/or as specified by logic and/or rules of a media file management application and/or based on a user selection and/or preference. The media type table 544b may, for example, be utilized at 304 (and/or 306) of FIG. 3 and/or 612 (and/or 614) of FIG. 6 herein.

In some embodiments, fewer or more data fields than are shown may be associated with the data tables 544a-b. Only a portion of one or more databases and/or other data stores is necessarily shown in any of FIG. 5, for example, and other database fields, columns, structures, orientations, quantities, and/or configurations may be utilized without deviating from the scope of some embodiments. Further, the data shown in the various data fields is provided solely for exemplary and illustrative purposes and does not limit the scope of embodiments described herein nor imply that any such data is accurate.

Referring now to FIG. 6, a flow diagram of a method 600 according to some embodiments is shown. In some embodiments, the method 600 may be performed and/or implemented by and/or otherwise associated with one or more specialized and/or computerized processing devices (e.g., the user devices 102a-n, 402, the controller device 110, and/or the application 142a-n, 442a of FIG. 1 and/or FIG. 4 herein), specialized computers, computer terminals, computer servers, computer systems and/or networks, and/or any combinations thereof. According to some embodiments, the method 600 may be implemented, facilitated, and/or performed by or otherwise associated with the systems 100, 400 of FIG. 1 and/or FIG. 4 herein. In some embodiments, the method 600 may be embodied in, facilitated by, and/or otherwise associated with various input mechanisms and/or interfaces (e.g., the interfaces 720a-b of FIG. 7A and/or FIG. 7B herein) such as may be provided by and/or on any or all of the devices described herein. In some embodiments, the method 600 may comprise and/or otherwise be associated with one or more of the methods 200, 300 of FIG. 2 and/or FIG. 3 herein, and/or one or more portions or combinations thereof.

In some embodiments, the method 600 may comprise scanning file storage locations, at 602. Various file and/or data storage structure locations, local, remote, networked, and/or cloud-based may, for example, be queried, accessed, and/or otherwise interfaced with to search for information relating to (and including) media files of a user. In some embodiments, different searches and/or search parameters may be utilized depending upon the type and/or format of media file located.

According to some embodiments, the method 600 may comprise determining data items descriptive of a media file, at 604. One or more DRM files and/or data stores, copies of purchase receipts and/or transaction data, user account data, etc. may, for example, be determined to be associated with one or more media files. In such a manner, for example, a profile may be constructed that may be utilized to determine a likelihood of any particular media file being (i) available and/or (ii) authentic. According to some embodiments, commonality of titles, SKU numbers, ISBNs, purchase totals, purchase dates, DRM data, etc., may be utilized to associate data with a media file.

In some embodiments, the method 600 may comprise determining an authenticity of a media file, at 606. The data determined at 604 and/or the profile constructed thereof, for example, may be utilized to determine one or more quantitative and/or qualitative metrics descriptive of a likelihood of a media file being authentic. In some embodiments, the authenticity may be expressed in terms of a score. Any given media file may, for example, have a certain number of related files and/or certain data that would be expected to be associated therewith in the case that the media file is authentic. According to some embodiments, a score may be developed to represent the total percentage of such expected files and/or data that have been located with respect to the media file. In some embodiments, different files and/or data may be weighted differently. An e-mailed version of a transaction receipt naming a particular media file and/or listing an activation and/or purchase code thereof, for example, may cause the media file's score to be set at a maximum value, while possession of the media file and any DRM information, but without a transaction confirmation, may produce or warrant a lesser score. In some embodiments, the authenticity may be determined for a particular media file, a group of media files (e.g., a library), for a particular user and/or user account, etc.

According to some embodiments, the score may be determined based on a tiered analysis of located media file-related data. In the case that all files and/or file references that were searched for were found on a consumers device(s) (e.g., in all expected locations) and sales receipts from a retailer were obtained, for example, the authenticity score may comprise a first value, class, and/or indicator such as “Verified”. In the case that all files and/or file references that were searched for were found on the consumer's device(s) (e.g., in all expected locations) and, user-entered data and publisher transaction level sales information (e.g., ZIP code match, etc.) is also obtained, the authenticity score may comprise a second (and/or lesser) value, class, and/or indicator such as “Highly Likely”. In the case that all files and/or file references that were searched for were found on the consumer's device(s) (e.g., in all expected locations) but no transaction information could be verified, the authenticity score may comprise a third (and/or lesser) value, class, and/or indicator such as “Likely”. In the case that all files and/or file references that were searched for were found on the consumer's device(s) but were not found in the expected locations or not all searched files/data were located, the authenticity score may comprise a fourth (and/or lesser) value, class, and/or indicator such as “Suspect”. In some embodiments of “Suspect”, only some files and/or file references that were searched for were found on the consumer's device(s) and not in the expected locations or located data is determined to have been distributed, tampered with, and/or otherwise suspect or indeterminate. In the case where it is known that the file (and the content owner) allows it to be distributed/sold from legitimate source/sales outlet without any traceable means (e.g., no DRM and/or watermark) and no other available third-party data is available in and/or to the system (e.g., a sales receipt, fulfillment transaction data, etc.), the authenticity score may comprise a fifth value, class, and/or indicator such as “Not Verifiable”, which does not necessarily mean it is less than the other authenticity scores.

According to some embodiments, the method 600 may comprise providing a media file library, at 608. An interface (such as the example interfaces 420, 720a-b of FIG. 4, FIG. 7A, and/or FIG. 7B herein) may, for example, be output to a user via a user device. In some embodiments, the interface may provide a single-source for a user to view, aggregate, edit metadata, and/or otherwise manage media files of differing types. In some embodiments, the interface and/or application thereof may not be capable of opening one or more of the media files represented by the interface. According to some embodiments, the library may be accessible to the user via multiple devices and/or locations. Information descriptive of the library and/or interface may, for example, be stored in the cloud.

In some embodiments, the method 600 may comprise providing media file-based content, at 610. Via the interface and/or based on the authenticity score, for example, one or more third-party offers, promotions, news feeds, discounts, and/or rewards may be provided. In the case that a media file is ranked as “Verified”, for example, an offer targeted to the user and/or based on the media file itself may comprise an offer for a free upgrade to a newer version of a digital media title through the original retailer of the title or a discount of fifty percent (50%) off of the digital media title through a new retailer. In the case that a media file is ranked as “Highly Likely”, for example, an offer targeted to the user and/or based on the media file itself may comprise an offer for a discount of forty percent (40%) off an upgraded version of a digital media title through the original retailer or a discount of twenty percent (20%) off of digital media titles through a new retailer. In the case that a media file is ranked as “Likely”, for example, an offer targeted to the user and/or based on the media file itself may comprise an offer for a discount of twenty percent (20%) off of an upgraded version of a digital media title through the original retailer or a discount of ten percent (10%) off of digital media titles through a new retailer. In the case that a media file is ranked as “Suspect”, for example, an offer targeted to the user and/or based on the media file itself may comprise an offer for a discount of ten percent (10%) off of a future purchase. In the case that a media file is ranked as “Non-verifiable”, for example, no offer, or promotion may be provided—e.g., but an advertisement and/or other content may instead be provided.

According to some embodiments, the method 600 may comprise determining an application associated with a media file, at 612, and/or causing the application to open the media file, at 614. In the case that the application conducting and/or associated with the method 600 cannot open the media file (e.g., due to a proprietary media file format), for example, a second and/or alternate program may be called, executed, and/or otherwise interfaced to open the desired media file. According to some embodiments, this functionality may be implemented across devices and/or hardware platforms. A user may utilize a PC and/or mobile device, for example, and cause an iBook® to be launched on the user's iPad®. In some embodiments, the determining of the launch application may comprise determining a default and/or preferred launch application from a plurality of available launch applications (e.g., utilizing the media type table 540b and/or the preferred application field 544b-3 thereof). Such a preferred application may be set by default by a third-party, by a manufacturer and/or provided of a media file management application, and/or may be based on one or more user selections and/or preferences.

Turning to FIG. 7A and FIG. 7B, example interfaces 720a-b according to some embodiments are shown. In some embodiments, the interfaces 720a-b may comprise a web page, web form, database entry form, Application Programming Interface (API), spreadsheet, table, and/or application or other GUI via which a media file owner/user and/or other entity may view, open, and/or manage media files (such as e-books of different formats), and/or via which a user may receive and/or interact with targeted content such as one or more offers, advertisements, promotions, and/or rewards. The interfaces 720a-b may, for example, comprise a front-end of a media file management program (and/or portion thereof) and/or platform programmed and/or otherwise configured to execute, conduct, and/or facilitate any of the various methods 200, 300, 600 of FIG. 2, FIG. 3, and/or FIG. 6 and/or portions or combinations thereof described herein. In some embodiments, the interfaces 720a-b may be output via a computerized device such as one or more of the user devices 102a-n, 402 and/or the controller device 110 of FIG. 1 and/or FIG. 4 herein. In some embodiments, the example interfaces 720a-b may comprise interface outputs of (and/or otherwise associated with) a GUI utilized to manage media files and/or related information, such as may be implemented and/or provided as described herein.

A first example interface 720a as depicted in FIG. 7A, for example, may provide a graphical representation of a bookshelf such as a virtual bookshelf 702 as depicted. The virtual bookshelf 702 may comprise icons, graphics (e.g., artwork, album covers, etc.), and/or links representing various media files such as a plurality of e-books as depicted. According to some embodiments, the first example interface 720a may comprise a display menu 704 that provides options regarding how (and/or what) information is displayed via the virtual bookshelf 702. The display menu 704 may, for example, provide a filter mechanism that allows a user to choose which set and/or subset of media files is displayed (and/or how such media files are grouped, etc.). As shown in the first example interface 720a, the option for displaying “All Books”, along with a respective count of a total of twenty-four (24) books is selected and the corresponding media files are represented via the virtual bookshelf 702. According to some embodiments, the virtual bookshelf 702 may comprise one or more badges 702-1. The badges 702-1 may, for example, comprise one or more images, icons, artwork, trademarks, etc. that provide increased efficiency of recognition for any given e-book (and/or other media file) regarding which format the title is in and/or which device(s) the file is configured to operate on. In some embodiments (as described herein), the virtual bookshelf 702 and/or media files associated therewith (and/or data descriptive thereof) may be utilized to provide content to a user such as one or more targeted advertisements, rewards, and/or offers. Such content may be provided by the first example interface 720a such as via one or more offer links 706a-d. The offer links 706a-d may, for example, be provided and/or selected based on the contents of the virtual bookshelf 702 and/or based on other data descriptive of and/or associated with the user of the first example interface 720a. According to some embodiments, a user's interaction with indications of media files on the virtual bookshelf 702 may cause and/or initiate various actions. In the case that a user selection of a particular e-book 708 is received, for example, the first example interface 720a may be altered, one or more different interfaces may be provided, and/or one or more different applications may be launched.

Turning to FIG. 7B, for example, a selection of the particular e-book 708 via the virtual bookshelf 702 may cause a display of a second example interface 720b. The second example interface 720b may, for example, provide a user with more detailed information associated with the selected e-book 708 such as an enhanced and/or interactive graphical view of the selected e-book 708 and/or bibliographic and/or format information 710. In some embodiments, one or more additional offer links 706e-g and/or one or more of the offer links 706d from the first example interface 720a, may be provided. In some embodiments, the second example interface 720b may comprise and/or provide the user with one or more of an “open” button 712, a “reveal” button 714, and/or an “archive” button 716. The open button 712 may, for example, cause the particular e-book 708 to be launched and/or executed (i.e., opened for viewing by the user). As described herein, such as in the case that the second example interface 720b (and/or application that causes an outputting of the second example interface 720b) is not capable of launching a media file for the particular e-book 708, one or more other applications (e.g., a preferred application) and/or devices may be selected, called, launched, etc. In some embodiments, the reveal button 714 may allow a user to identify and/or determine a storage location associated with the particular e-book 708 and/or identify and/or determine an appropriate device on which a media file may be opened. In some embodiments, the archive button 716 may allow the user to backup, store, archive, and/or otherwise save or protect one or more media files such as a media file associated with the particular e-book 708. According to some embodiments, a “Return to Bookshelf” button 718 may be provided that causes a display (and/or re-display) of the first example interface 720a and/or the virtual bookshelf 702.

While the example interfaces 720a-b are depicted herein with respect to a specific example of particular media files and/or media file types, other media files and/or media file types may be provided in accordance with some embodiments. While the depicted virtual bookshelf 702 comprises graphical representations of a user's e-books in a single library format, for example, other layouts, file types, and/or content may also or alternatively be utilized by and/or incorporated into the interfaces 720a-b.

While various components of the interfaces 720a-b have been depicted with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

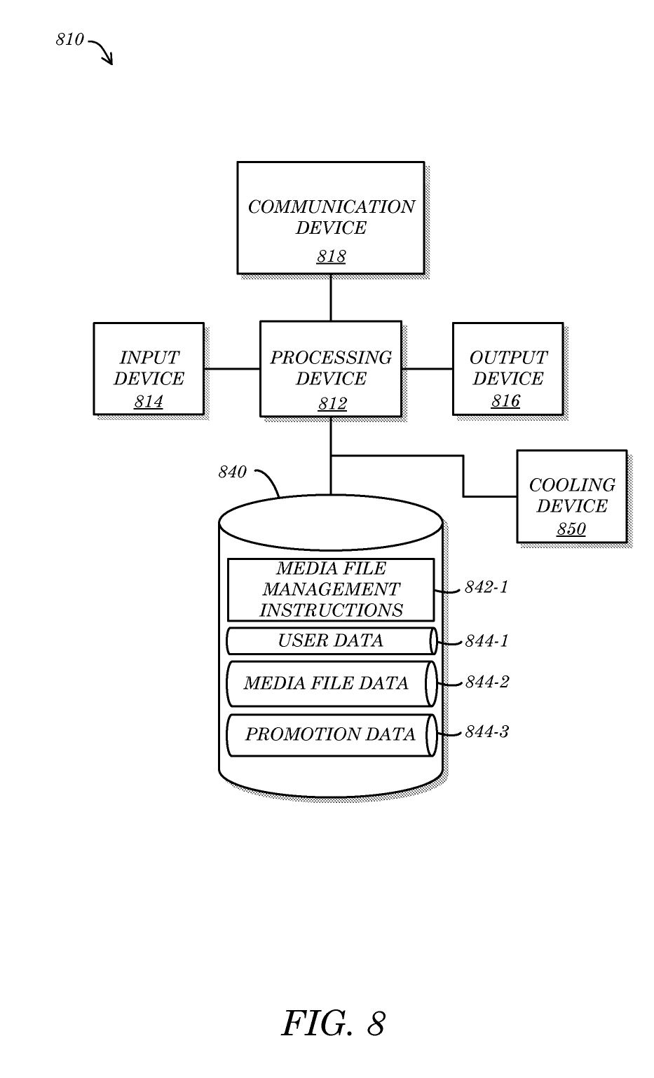

Turning to FIG. 8, a block diagram of an apparatus 810 according to some embodiments is shown. In some embodiments, the apparatus 810 may be similar in configuration and/or functionality to the user devices 102a-n, 402, the controller device 110, and/or the third-party devices 106, 406a-f of FIG. 1 and/or FIG. 4 herein. The apparatus 810 may, for example, execute, process, facilitate, and/or otherwise be associated with the methods 200, 300, 600 of FIG. 2, FIG. 3, and/or FIG. 6 herein, and/or portions and/or combinations hereof. In some embodiments, the apparatus 810 may comprise a processing device 812, an input device 814, an output device 816, a communication device 818, a memory device 840, and/or a cooling device 850. Fewer or more components 812, 814, 816, 818, 840, 850 and/or various configurations of the components 812, 814, 816, 818, 840, 850 may be included in the apparatus 810 without deviating from the scope of embodiments described herein.

According to some embodiments, the processing device 812 may be or include any type, quantity, and/or configuration of electronic and/or computerized processor that is or becomes known. The processing device 812 may comprise, for example, an Intel® IXP 2800 network processor or an Intel® XEON™ Processor coupled with an Intel® E9501 chipset. In some embodiments, the processing device 812 may comprise multiple inter-connected processors, microprocessors, and/or micro-engines. According to some embodiments, the processing device 812 (and/or the apparatus 810 and/or other components thereof) may be supplied power via a power supply (not shown) such as a battery, an Alternating Current (AC) source, a Direct Current (DC) source, an AC/DC adapter, solar cells, and/or an inertial generator. In some embodiments, such as in the case that the apparatus 810 comprises a server such as a blade server, necessary power may be supplied via a standard AC outlet, power strip, surge protector, and/or Uninterruptible Power Supply (UPS) device.

In some embodiments, the input device 814 and/or the output device 816 are communicatively coupled to the processing device 812 (e.g., via wired and/or wireless connections, traces, and/or pathways) and they may generally comprise any types or configurations of input and output components and/or devices that are or become known, respectively. The input device 814 may comprise, for example, a keyboard that allows an operator of the apparatus 810 to interface with the apparatus 810. The output device 816 may, according to some embodiments, comprise a display screen and/or other practicable output component and/or device. The output device 816 may, for example, provide indications of media files and/or targeted content associated therewith (e.g., via a website and/or via a computer device and/or interface such as the example interfaces 420, 720a-b of FIG. 4, FIG. 7A, and/or FIG. 7B herein). According to some embodiments, the input device 814 and/or the output device 816 may comprise and/or be embodied in a single device such as a touch-screen monitor.

In some embodiments, the communication device 818 may comprise any type or configuration of communication device that is or becomes known or practicable. The communication device 818 may, for example, comprise a Network Interface Card (NIC), a telephonic device, a cellular network device, a router, a hub, a modem, and/or a communications port or cable. In some embodiments, the communication device 818 may be coupled to provide data to (and/or receive data from) a user device, such as in the case that the apparatus 810 is utilized to provide facilitate media file management and/or media file-related content delivery. According to some embodiments, the communication device 818 may also or alternatively be coupled to the processing device 812. In some embodiments, the communication device 818 may comprise an Infrared Radiation (IR), RF, Near-Field Communication (NFC), Bluetooth™, and/or Wi-Fi® network device coupled to facilitate communications between the processing device 812 and another device (such as a user device and/or a third-party device).

The memory device 840 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM). The memory device 840 may, according to some embodiments, store one or more of media file management instructions 842-1, user data 844-1, media file data 844-2, and/or promotion data 844-3. In some embodiments, the media file management instructions 842-1 may be utilized by the electronic processor 812 to provide output information via the output device 816 and/or the communication device 818.

According to some embodiments, the media file management instructions 842-1 may be operable to cause the processing device 812 to access and/or process the user data 844-1, media file data 844-2, and/or promotion data 844-3, as described herein (e.g., in accordance with the methods 200, 300, 600 of FIG. 2, FIG. 3, and/or FIG. 6 herein). User data 844-1, media file data 844-2, and/or promotion data 844-3 received via the input device 814 and/or the communication device 818 may, for example, be analyzed, sorted, filtered, decompressed, ranked, scored, plotted, and/or otherwise processed by the processing device 812 in accordance with the media file management instructions 842-1. In some embodiments, user data 844-1, media file data 844-2, and/or promotion data 844-3 may be fed by the processing device 812 through one or more mathematical and/or statistical formulas, rule sets, policies, and/or models in accordance with the media file management instructions 842-1 to determine media files associated with a user, determine whether such media files are available and/or authentic, and/or provide content to the user based on media file-related data, as described herein.

Any or all of the exemplary instructions and data types described herein and other practicable types of data may be stored in any number, type, and/or configuration of memory devices that is or becomes known. The memory device 840 may, for example, comprise one or more data tables or files, databases, table spaces, registers, and/or other storage structures. In some embodiments, multiple databases and/or storage structures (and/or multiple memory devices 840) may be utilized to store information associated with the apparatus 810. According to some embodiments, the memory device 840 may be incorporated into and/or otherwise coupled to the apparatus 810 (e.g., as shown) or may simply be accessible to the apparatus 810 (e.g., externally located and/or situated).

In some embodiments, the apparatus 810 may comprise the cooling device 850. According to some embodiments, the cooling device 850 may be coupled (physically, thermally, and/or electrically) to the processing device 812 and/or to the memory device 840. The cooling device 850 may, for example, comprise a fan, heat sink, heat pipe, radiator, cold plate, and/or other cooling component or device or combinations thereof, configured to remove heat from portions or components of the apparatus 810.

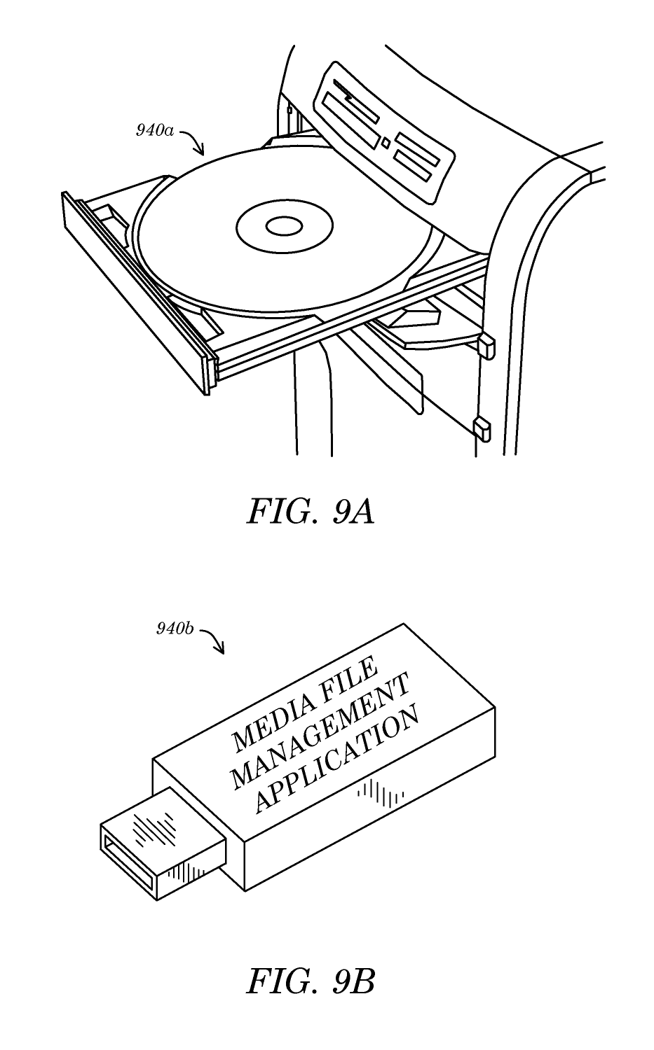

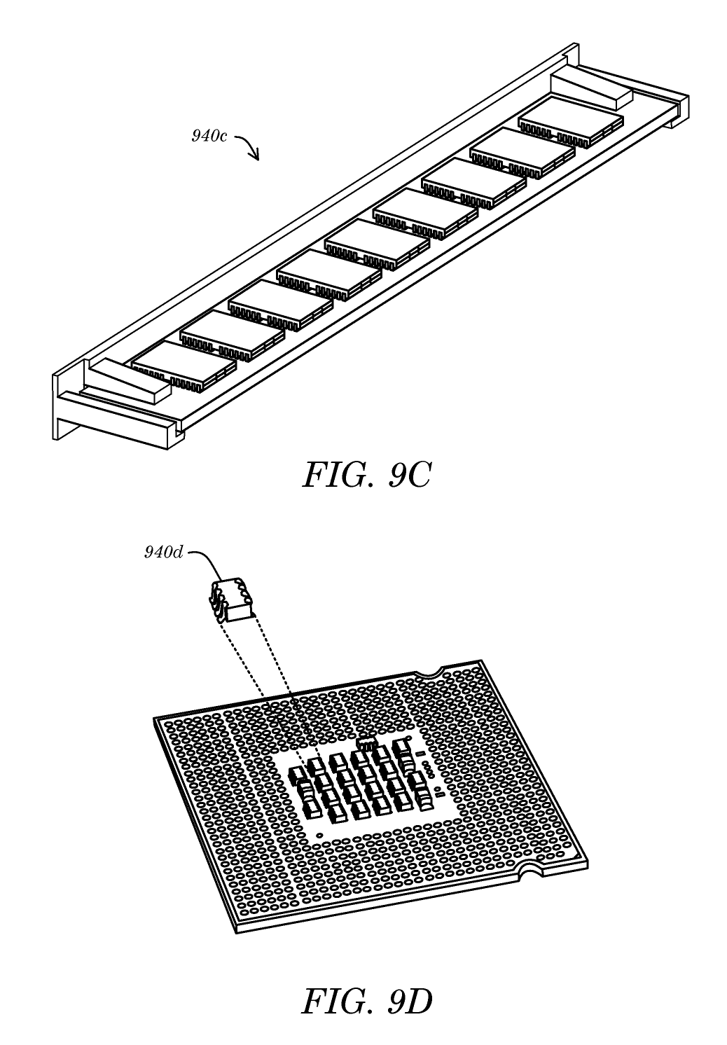

Referring to FIG. 9A, FIG. 9B, FIG. 9C, and FIG. 9D, perspective diagrams of exemplary data storage devices 940a-d according to some embodiments are shown. The data storage devices 940a-d may, for example, be utilized to store instructions and/or data such as media file management instructions 842-1, user data 844-1, media file data 844-2, and/or promotion data 844-3, each of which is described in reference to FIG. 8 herein. In some embodiments, instructions stored on the data storage devices 940a-d may, when executed by a processor (such as the processing device 812 of FIG. 8), cause the implementation of and/or facilitate any of the various methods 200, 300, 600 of FIG. 2, FIG. 3, and/or FIG. 6 described herein.

According to some embodiments, the first data storage device 940a may comprise a CD, CD-ROM, DVD, Blu-Ray™ Disc, and/or other type of optically-encoded disk and/or other computer-readable storage medium that is or becomes know or practicable. In some embodiments, the second data storage device 940b may comprise a USB keyfob, dongle, and/or other type of flash memory data storage device that is or becomes know or practicable. According to some embodiments, the third data storage device 940c may comprise RAM of any type, quantity, and/or configuration that is or becomes practicable and/or desirable. In some embodiments, the third data storage device 940c may comprise an off-chip cache such as a Level 2 (L2) or Level 3 (L3) cache memory device. According to some embodiments, the fourth data storage device 940d may comprise an on-chip memory device such as a Level 1 (L1) cache memory device.

The data storage devices 940a-d may generally store program instructions, code, and/or modules that, when executed by an electronic and/or computerized processing device cause a particular machine to function in accordance with embodiments described herein. In some embodiments, the data storage devices 940a-d depicted in FIG. 9A, FIG. 9B, FIG. 9C, and FIG. 9D are representative of a class and/or subset of computer-readable media that are defined herein as “computer-readable memory” (e.g., memory devices as opposed to transmission devices). While computer-readable media may include transitory media types, as utilized herein, the term computer-readable memory is limited to non-transitory computer-readable media.

### III. Terms

Some embodiments described herein are associated with a “user device” or a “network device”. As used herein, the terms “user device” and “network device” may be generally used interchangeably and may refer to any device that can communicate via a network. Examples of user or network devices include a PC, a workstation, a server, a printer, a scanner, a facsimile machine, a copier, a Personal Digital Assistant (PDA), a storage device (e.g., a disk drive), laptop, tablet, a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, potential customers, potential consumers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

As utilized herein, the terms “incentive”, “award”, and/or “reward” may generally be utilized to refer to any or all various types, quantities, and/or configurations of benefits. A benefit may comprise, for example, but is not limited to, a discount, a free unit of product, a substitute product, a replacement product, a number of points, a free and/or discounted service, a special feature, and/or any other object and/or thing of real and/or perceived value. In some embodiments, the utilization and/or timing of a benefit may be definitive of a particular subset and/or type of benefit. A benefit utilized to motivate and/or incent a particular action (e.g., a purchasing a media file upgrade and/or switching to a different media file format), for example, may be considered an incentive when offered, but may then be considered an award and/or reward when earned once the desired action has been achieved and/or realized.

### IV. Rules of Interpretation

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments.

Neither the Title (set forth at the beginning of the first page of this patent application) nor the Abstract (set forth at the end of this patent application) is to be taken as limiting in any way the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including the specification, its claims and figures, and anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to allow for distinguishing that particular referenced feature from another feature that is described by the same term or by a similar term. For example, a “first widget” may be so named merely to allow for distinguishing it in one or more claims from a “second widget”, so as to encompass embodiments in which (1) the “first widget” is or is the same as the “second widget” and (2) the “first widget” is different than or is not identical to the “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; (3) does not indicate that either widget ranks above or below any other, as in importance or quality; and (4) does not indicate that the two referenced widgets are not identical or the same widget. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
aggregating, by a processing device and via a single software application, information descriptive of a plurality of libraries of electronic media, each library only being accessible via a different application;
providing, by the processing device, access to each library of the plurality of libraries via the single software application;
defining, by the processing device, an authenticity score for each item of electronic media in each library of the plurality of libraries; and
selecting, by the processing device and based at least in part on at least a portion of the authenticity scores, at least one of (1) an advertisement, (2) a reward, and (3) a promotion.

2. The method of claim 1, further comprising:
providing, by the processing device, the selected at least one of (1) an advertisement, (2) a reward, and (3) a promotion.

3. The method of claim 1, further comprising:
causing, by the processing device, a backup of the plurality of libraries.

4. The method of claim 1, wherein the aggregating comprises:
scanning, by the processing device, a plurality of storage locations associated with a user.

5. The method of claim 4, wherein the plurality of storage locations comprise at least two of: (i) a network drive; (ii) a cloud storage drive; (iii) an online account information retrieval system; and (iv) a local drive or storage device.

6. The method of claim 1, wherein the providing of the access via the single software application comprises:
providing an interface of the single software application, the interface comprising a listing of electronic media items from each library of the plurality of libraries;
receiving, via the interface of the single software application, an indication of a user selection of an electronic media item from the listing of electronic media items;
determining, based on the selected electronic media item, a separate software application associated with the selected electronic media item; and
causing, by the single software application, the selected electronic media item to be opened by the separate software application.

7. The method of claim 1, wherein the defining of the authenticity score for each electronic media item comprises:
determining a plurality of stored data files descriptive of one of the electronic media items;
determining, based on the plurality of stored data files, a likelihood that the one of the electronic media files is authentic; and
defining, for the one of the electronic media files and based on the likelihood that the one of the electronic media files is authentic, the authenticity score for the one of the electronic media files.

8. A method, comprising:
scanning, by a processing device and in accordance with instructions of a first software application, a plurality of file storage locations associated with a user of the processing device;
determining, by the processing device and based on the scanning, a plurality of data items descriptive of a media file, wherein the media file cannot be displayed by the first software application;
determining, by the processing device and based on the plurality of data items descriptive of the media file, an authenticity of the media file; and
providing, by the processing device and via the first software application and in response to the determining of the authenticity of the media file, a data library interface comprising a listing of the media file.

9. The method of claim 8, further comprising:
receiving, by the processing device and via the data library interface of the first software application, an indication of a user selection of the listing of the media file; and
causing, by the processing device and via the first software application and in response to the receiving of the indication of the user selection, an opening of the media file via a second software application.

10. The method of claim 8, wherein the plurality of file storage locations comprise at least two of: (i) a network drive; (ii) a cloud storage drive; (iii) an online account information retrieval system; and (iv) a local drive or storage device.

11. The method of claim 8, further comprising:
providing, by the processing device and via the data library interface and based on the determining of the authenticity of the media file, at least one of: (i) a promotion; (ii) and offer; and (iii) a reward.

12. An apparatus, comprising:
a processor; and
a memory device in communication with the processor, the memory device storing instructions of a first software application that when executed by the processor result in:
scanning a plurality of file storage locations associated with a user of the apparatus;
determining, based on the scanning, a plurality of data items descriptive of a media file, wherein the media file cannot be displayed by the first software application;
determining, by the processing device and based on the plurality of data items descriptive of the media file, an authenticity of the media file; and
providing, by the processing device and via the first software application and in response to the determining of the authenticity of the media file, a data library interface comprising a listing of the media file.

13. The apparatus of claim 12, wherein the instructions, when executed by the processor, further result in:
receiving an indication of a user selection of the listing of the media file; and
causing, in response to the receiving of the indication of the user selection, an opening of the media file via a second software application.

14. The apparatus of claim 12, wherein the plurality of file storage locations comprise at least two of: (i) a network drive; (ii) a cloud storage drive; (iii) an online account information retrieval system; and
(iv) a local drive or storage device.

15. The apparatus of claim 12, wherein the instructions, when executed by the processor, further result in:
providing, based on the determining of the authenticity of the media file, at least one of: (i) a promotion; (ii) and offer; and (iii) a reward.
